(19) United States
(12) Patent Application Publication
(10) Pub. No.: US 2014/0274750 A1
(43) Pub. Date: Sep. 18, 2014

(54) SEQUENCE ASSEMBLY USING OPTICAL MAPS

(71) Applicant: OpGen, Inc., Gaithersburg, MD (US)

(72) Inventor: Deacon John Sweeney, Gaithersburg, MD (US)

(73) Assignee: OpGEN, INC., Gaithersburg, MD (US)

(21) Appl. No.: 14/212,612

(22) Filed: Mar. 14, 2014

Related U.S. Application Data
(60) Provisional application No. 61/790,899, filed on Mar. 15, 2013.

(51) Int. Cl. G06F 19/22

(52) U.S. Cl. CPC G06F 19/22
USPC 506/8

(57) ABSTRACT

The invention generally relates to sequence assembly and particularly to ordering the alignment of contigs to reference maps. The invention provides systems and methods for assembling contigs by aligning those contigs to a reference map in descending order of placement confidence. Each placement decreases the number of possible placements for the remaining contigs, which otherwise would have been likely to match in numerous places. Contigs are thereby placed along the reference genome with confidence and thus can be assembled into a genome-scale sequence assembly.

### RELATED APPLICATION

The present application claims the benefit of and priority to U.S. provisional application Ser. No. 61/790,899, filed Mar. 15, 2013, the content of which is incorporated by reference herein in its entirety.

### FIELD OF THE INVENTION

The invention generally relates to sequence assembly and particularly to ordering the alignment of contigs to reference maps.

### BACKGROUND

Studying genomes has the potential to reveal promising targets for the treatment of cancer and other diseases. Determining the genetic content of humans, animals, and even infectious agents can be done by DNA sequencing. Contemporary sequencing technologies produce huge amounts of data rapidly. For example, some sequencing instruments can cover as much as a third of the data of the human genome in a single instrument run. Unfortunately, capturing all of this data is not enough to provide a genome-scale sequence.

Modern sequencing instrument typically produce large numbers of sequence reads that can be very short, less than even about 50 base pairs per read. Those sequence reads must be assembled together to obtain complete genomic sequences. Typical assembly algorithms implemented by computers can join together a number of closely-related reads into contigs—i.e., “contiguous” groups of reads—and then assemble the contigs. One approach to assembling contigs is to align each contig onto a reference, such as a physical map of a target genome. There are different approaches to making the physical maps including, for example, sequence tags and fluorescent probe approaches. One useful type of physical map is an optical map, a physical map of ordered restriction sites along a genome.

Contigs can be aligned to a reference optical map by making in silico optical maps of the contigs and aligning the contig optical map to the reference optical map. However, particularly with short contigs, alignment can be difficult due to non-unique placement possibilities and imperfect maps. Additionally, for the very large number of very short contigs produced by modern sequencing, alignment to a reference map can be computationally intractable. A match filtering algorithm has been attempted that first places sequences with a unique significant match (Nagarajan, et al., 2008, Bioinformatics 24(10):1229-1235). But that algorithm requires determining the significance of every possible contig-to-map match in order to starting placing contigs. Even with optical maps, contig assembly is a computational bottleneck that is problematic in studying genomes.

### SUMMARY

The invention provides systems and methods for assembling contigs by aligning those contigs to a reference map in descending order of placement confidence. Each placement decreases the number of possible placements for the remaining contigs, which otherwise would have been likely to match in numerous places. Contigs are thereby placed along the reference genome with confidence and thus can be assembled into a genome-scale sequence assembly. Placement confidence can be evaluated for each contig prior to assembly and without reference to the map according to a confidence logic algorithm. Thus, assembly does not require first trying every possible contig-to-map match prior to accepting the first unique significant match. The contigs can be ordered for assembly by the confidence logic algorithm using a computer system, and then assembled to the map by the computer system. Since the confidence logic algorithm for sequence placement (CLASP) is applied independently of the assembly and without performing every pair-wise comparison required for match filtering, the number of computational steps is decreased greatly and those steps can be executed separately, independently of one another. Separating and decreasing the computational steps allows contig assembly to be done more rapidly, allowing contig assembly to keep pace with raw data collection from modern sequencing systems. Since this computational bottleneck in genomic studies is resolved, genome sequencing results can be turned around rapidly and results can be put into the hands of researchers and medical geneticists at a pace commensurate with the sequencing technology.

In certain aspects, the invention provides a method of assembling sequence contigs that includes obtaining a plurality of sequence contigs, identifying a subset of the plurality of sequence contigs that meet a placement criterion, aligning the contigs of the subset to a genomic map, and aligning a remainder of the contigs to the genomic map. Preferably, the subset is identified prior to the aligning. Aligning the remainder of contigs may include identifying a subset of the remainder that meet the placement criterion, aligning the contigs of the subset of the remainder to the genomic map, and aligning remaining contigs to the genomic map. Any suitable placement criterion can be used such as, for example, length, a quality score, or a similarity metric (e.g., a number of cutting sites per length of nucleic acid molecule for a restriction enzyme). In some embodiments, the subset that is aligned first includes those contigs that are most dissimilar to all of the other contigs in the plurality of sequence contigs.

Methods of the invention can include making an optical map for the reference map. Optical mapping can include generating the genomic map by introducing nucleic acid from the sample to a charged substrate (e.g., derivatized glass) so that the nucleic acids become elongated and fixed on the substrate in a manner in which the nucleic acids remain accessible for enzymatic reaction, digesting the nucleic acids enzymatically to produce one or more restriction digests, and constructing a map from the restriction digests. The contigs may be used to produce in silico contig optical maps.

### BRIEF DESCRIPTION OF THE DRAWINGS

FIG. 1 shows a method of optical mapping.

FIG. 2 gives a diagram for methods of assembling contigs.

FIG. 3 depicts a system for genomic assembly.

FIG. 4 illustrates viewing an assembly according to certain embodiments.

### DETAILED DESCRIPTION

The invention generally relates to algorithms for contig assembly that makes complex problems tractable by evaluating contigs for placement confidence, so that contigs can be placed in order of placement confidence with the result that small, hard-to-place contigs are placed within a smaller area of a map than the entirety of the map. In general, sequence information is obtained from a sample nucleic acid by sequencing in the form of contigs or sequence reads to be assembled into contigs. Those contigs are used to create in silico contig optical maps. The contig optical maps are evaluated for placement confidence. Any method of evaluating placement confidence can be used including, for example, biological or mathematical measures from the source sequence reads, the contigs, or the contig optical maps. Once the confidence is evaluated, the contigs are then aligned to a reference map in order of confidence. By the time the smallest or most difficult-to-align contigs are to be aligned, the candidate placement areas are diminished by the earlier contigs. Placement may include aligning the contigs to the reference map.

Each of the following sections addresses considerations for one of a variety of topics relevant to embodiments of the invention, including sample extraction, optical mapping, and using optical maps to achieve contig extension and alignment of extended contigs on a per-chromosome basis.

### Sample Nucleic Acids

Nucleic acids include deoxyribonucleic acid (DNA), ribonucleic acid (RNA), or both. Nucleic acids can be synthetic or derived from naturally occurring sources. In one embodiment, nucleic acids are isolated from a biological sample containing a variety of other components, such as proteins, lipids and non-sample nucleic acids. Nucleic acids can be obtained from any cellular material, obtained from a human or other mammal, plant, or microorganism (e.g., bacterium, fungus, virus or any other cellular organism). In certain embodiments, the nucleic acids are obtained from a single cell. Biological samples for use in the present invention include viral particles or preparations. Nucleic acids can be obtained directly from an organism or from a biological sample obtained from an organism, e.g., from blood, urine, cerebrospinal fluid, seminal fluid, saliva, sputum, stool and tissue. Any tissue or body fluid specimen may be used as a source for nucleic acid for use in the invention. Nucleic acids can also be isolated from cultured cells, such as a primary cell culture or a cell line. The cells or tissues from which nucleic acids are obtained can be infected with a virus or other intracellular pathogen. A sample can also be total RNA extracted from a biological specimen, a cDNA library, viral, or genomic DNA.

Nucleic acid obtained from biological samples typically is fragmented to produce suitable fragments for analysis. In one embodiment, nucleic acid from a biological sample is fragmented by sonication. Generally, nucleic acid can be extracted, isolated, amplified, or analyzed by a variety of techniques such as those described by Green and Sambrook, Molecular Cloning: A Laboratory Manual (Fourth Edition), Cold Spring Harbor Laboratory Press, Woodbury, N.Y. 2,028 pages (2012); or as described in U.S. Pat. No. 7,957,913; U.S. Pat. No. 7,776,616; U.S. Pat. No. 5,234,809; U.S. Pub. 2010/0285578; and U.S. Pub. 2002/0190663. Nucleic acid molecules may be single-stranded, double-stranded, or double-stranded with single-stranded regions (for example, stem- and loop-structures).

Nucleic acid obtained from biological samples may be fragmented to produce suitable fragments for analysis. Template nucleic acids may be fragmented or sheared to desired length, using a variety of mechanical, chemical and/or enzymatic methods. Nucleic acid may be sheared by sonication, brief exposure to a DNase, RNase, hydroshear instrument, one or more restriction enzymes, transposase or nicking enzyme, exposure to heat plus magnesium, or other methods. RNA may be converted to cDNA, e.g., before or after fragmentation. In one embodiment, nucleic acid from a biological sample is fragmented by sonication.

A biological sample as described herein may be lysed, homogenized, or fractionated in the presence of a detergent or surfactant. The concentration of the detergent in the buffer may be about 0.05% to about 10.0%, e.g., 0.1% to about 2%. The detergent, particularly a mild one that is non-denaturing, can act to solubilize the sample. Detergents may be ionic (e.g., deoxycholate, sodium dodecyl sulfate (SDS), N-lauroylsarcosine, and cetyltrimethylammonium bromide) or nonionic (e.g., octyl glucoside, polyoxyethylene(9)dodecyl ether, digitonin, polysorbate 80 such as that sold under the trademark TWEEN by Uniqema Americas (Paterson, N.J.), (C₁₄H₂₂O(C₂H₄)ₙ) sold under the trademark TRITON X-100 by Dow Chemical Company (Midland, Mich.), polidocanol, n-dodecyl beta-D-maltoside (DDM), or NP-40 nonylphenyl polyethylene glycol). A zwitterionic reagent may also be used in the purification schemes, such as zwitterion 3-14 and 3-[(3-cholamidopropyl) dimethyl-ammonio]-1-propanesulfonate (CHAPS). Urea may also be added. Lysis or homogenization solutions may further contain other agents, such as reducing agents. Examples of such reducing agents include dithiothreitol (DTT), β-mercaptoethanol, dithioerythritol (DTE), glutathione (GSH), cysteine, cysteamine, tricarboxyethyl phosphine (TCEP), or salts of sulfurous acid.

### Amplification

In various embodiments, the nucleic acid is amplified, for example, from the sample or after isolation from the sample. Amplification refers to production of additional copies of a nucleic acid sequence and is generally carried out using polymerase chain reaction (PCR) or other technologies known in the art. The amplification reaction may be any amplification reaction known in the art that amplifies nucleic acid molecules, such as PCR, nested PCR, PCR-single strand conformation polymorphism, ligase chain reaction (Barany, F., 1991 The Ligase Chain Reaction in a PCR World, Genome Research, 1:5-16; Barany, F., 1991 Genetic disease detection and DNA amplification using cloned thermostable ligase, PNAS, 88:189-193; U.S. Pat. No. 5,869,252; and U.S. Pat. No. 6,100,099), strand displacement amplification and restriction fragments length polymorphism, transcription based amplification system, rolling circle amplification, and hyper-branched rolling circle amplification. Further examples of amplification techniques that can be used include, but are not limited to, quantitative PCR, quantitative fluorescent PCR (QF-PCR), multiplex fluorescent PCR (MF-PCR), real time PCR (RTPCR), restriction fragment length polymorphism PCR (PCR-RFLP), in situ rolling circle amplification (RCA), bridge PCR, picotiter PCR, emulsion PCR, transcription amplification, self-sustained sequence replication, consensus sequence primed PCR, arbitrarily primed PCR, degenerate oligonucleotide-primed PCR, and nucleic acid based sequence amplification (NABSA). Amplification methods that can be used include those described in U.S. Pat. Nos. 5,242,794; 5,494,810; 4,988,617; and 6,582,938. In certain embodiments, the amplification reaction is PCR as described, for example, in Dieffenbach and Dveksler, PCR Primer, a Laboratory Manual, 2nd Ed, 2003, Cold Spring Harbor Press, Plainview, N.Y.; U.S. Pat. No. 4,683,195; and U.S. Pat. No. 4,683,202, hereby incorporated by reference. Primers for PCR, sequencing, and other methods can be prepared by cloning, direct chemical synthesis, and other methods known in the art. Primers can also be obtained from commercial sources such as Eurofins MWG Operon (Huntsville, Ala.) or Life Technologies (Carlsbad, Calif.).

With these methods, a single copy of a specific target nucleic acid may be amplified to a level that can be detected by several different methodologies (e.g., sequencing, staining, hybridization with a labeled probe, incorporation of biotinylated primers followed by avidin-enzyme conjugate detection, or incorporation of 32P-labeled dNTPs). Further, the amplified segments created by an amplification process such as PCR are, themselves, efficient templates for subsequent PCR amplifications. After any processing steps (e.g., obtaining, isolating, fragmenting, or amplification), nucleic acid can be sequenced.

### Sequencing

Sequencing may be by any method known in the art. DNA sequencing techniques include classic dideoxy sequencing reactions (Sanger method) using labeled terminators or primers and gel separation in slab or capillary, sequencing by synthesis using reversibly terminated labeled nucleotides, pyrosequencing, 454 sequencing, Illumina/Solexa sequencing, allele specific hybridization to a library of labeled oligonucleotide probes, sequencing by synthesis using allele specific hybridization to a library of labeled clones that is followed by ligation, real time monitoring of the incorporation of labeled nucleotides during a polymerization step, polony sequencing, and SOLiD sequencing. Separated molecules may be sequenced by sequential or single extension reactions using polymerases or ligases as well as by single or sequential differential hybridizations with libraries of probes.

A sequencing technique that can be used includes, for example, use of sequencing-by-synthesis systems sold under the trademarks GS JUNIOR, GS FLX+ and 454 SEQUENCING by 454 Life Sciences, a Roche company (Branford, Conn.), and described by Margulies, et al., 2005, Genome sequencing in micro-fabricated high-density picotiter reactors, Nature, 437:376-380; U.S. Pat. No. 5,583,024; U.S. Pat. No. 5,674,713; and U.S. Pat. No. 5,700,673, the contents of which are incorporated by reference herein in their entirety. 454 sequencing involves two steps. In the first step of those systems, DNA is sheared into fragments of approximately 300-800 base pairs, and the fragments are blunt ended. Oligonucleotide adaptors are then ligated to the ends of the fragments. The adaptors serve as primers for amplification and sequencing of the fragments. The fragments can be attached to DNA capture beads, e.g., streptavidin-coated beads using, e.g., Adaptor B, which contains 5′-biotin tag. The fragments attached to the beads are PCR amplified within droplets of an oil-water emulsion. The result is multiple copies of clonally amplified DNA fragments on each bead. In the second step, the beads are captured in wells (pico-liter sized). Pyrosequencing is performed on each DNA fragment in parallel. Addition of one or more nucleotides generates a light signal that is recorded by a CCD camera in a sequencing instrument. The signal strength is proportional to the number of nucleotides incorporated. Pyrosequencing makes use of pyrophosphate (PPi) which is released upon nucleotide addition. PPi is converted to ATP by ATP sulfurylase in the presence of adenosine 5′ phosphosulfate. Luciferase uses ATP to convert luciferin to oxyluciferin, and this reaction generates light that is detected and analyzed.

Another example of a DNA sequencing technique that can be used is SOLiD technology by Applied Biosystems from Life Technologies Corporation (Carlsbad, Calif.). In SOLiD sequencing, genomic DNA is sheared into fragments, and adaptors are attached to the 5′ and 3′ ends of the fragments to generate a fragment library. Alternatively, internal adaptors can be introduced by ligating adaptors to the 5′ and 3′ ends of the fragments, circularizing the fragments, digesting the circularized fragment to generate an internal adaptor, and attaching adaptors to the 5′ and 3′ ends of the resulting fragments to generate a mate-paired library. Next, clonal bead populations are prepared in microreactors containing beads, primers, template, and PCR components. Following PCR, the templates are denatured and beads are enriched to separate the beads with extended templates. Templates on the selected beads are subjected to a 3′ modification that permits bonding to a glass slide. The sequence can be determined by sequential hybridization and ligation of partially random oligonucleotides with a central determined base (or pair of bases) that is identified by a specific fluorophore. After a color is recorded, the ligated oligonucleotide is removed and the process is then repeated.

Another example of a DNA sequencing technique that can be used is ion semiconductor sequencing using, for example, a system sold under the trademark ION TORRENT by Ion Torrent by Life Technologies (South San Francisco, Calif.). Ion semiconductor sequencing is described, for example, in Rothberg, et al., 2011, An integrated semiconductor device enabling non-optical genome sequencing, Nature 475:348-352; U.S. Pubs. 2009/0026082, 2009/0127589, 2010/0035252, 2010/0137143, 2010/0188073, 2010/0197507, 2010/0282617, 2010/0300559, 2010/0300895, 2010/0301398, and 2010/0304982, the content of each of which is incorporated by reference herein in its entirety. In ion semiconductor sequencing, DNA is sheared into fragments of approximately 300-800 base pairs, and the fragments are blunt ended. Oligonucleotide adaptors are then ligated to the ends of the fragments. The adaptors serve as primers for amplification and sequencing of the fragments. The fragments can be attached to a surface and are attached at a resolution such that the fragments are individually resolvable. Addition of one or more nucleotides releases a proton (H⁺), which signal is detected and recorded in a sequencing instrument. The signal strength is proportional to the number of nucleotides incorporated.

Another example of a sequencing technology that can be used is Illumina sequencing. Illumina sequencing is based on the amplification of DNA on a solid surface using fold-back PCR and anchored primers. Genomic DNA is fragmented, and adapters are added to the 5′ and 3′ ends of the fragments. DNA fragments that are attached to the surface of flow cell channels are extended and bridge amplified. The fragments become double stranded, and the double stranded molecules are denatured. Multiple cycles of the solid-phase amplification followed by denaturation can create several million clusters of approximately 1,000 copies of single-stranded DNA molecules of the same template in each channel of the flow cell. Primers, DNA polymerase and four fluorophore-labeled, reversibly terminating nucleotides are used to perform sequential sequencing. After nucleotide incorporation, a laser is used to excite the fluorophores, and an image is captured and the identity of the first base is recorded. The 3′ terminators and fluorophores from each incorporated base are removed and the incorporation, detection and identification steps are repeated. Sequencing according to this technology is described in U.S. Pub. 2011/0009278, U.S. Pub. 2007/0114362, U.S. Pub. 2006/0024681, U.S. Pub. 2006/0292611, U.S. Pat. No. 7,960,120, U.S. Pat. No. 7,835,871, U.S. Pat. No. 7,232,656, U.S. Pat. No. 7,598,035, U.S. Pat. No. 6,306,597, U.S. Pat. No. 6,210,891, U.S. Pat. No. 6,828,100, U.S. Pat. No. 6,833,246, and U.S. Pat. No. 6,911,345, each of which are herein incorporated by reference in their entirety.

Another example of a sequencing technology that can be used includes the single molecule, real-time (SMRT) technology of Pacific Biosciences (Menlo Park, Calif.). In SMRT, each of the four DNA bases is attached to one of four different fluorescent dyes. These dyes are phospholinked. A single DNA polymerase is immobilized with a single molecule of template single stranded DNA at the bottom of a zero-mode waveguide (ZMW). A ZMW is a confinement structure which enables observation of incorporation of a single nucleotide by DNA polymerase against the background of fluorescent nucleotides that rapidly diffuse in and out of the ZMW (in microseconds). It takes several milliseconds to incorporate a nucleotide into a growing strand. During this time, the fluorescent label is excited and produces a fluorescent signal, and the fluorescent tag is cleaved off. Detection of the corresponding fluorescence of the dye indicates which base was incorporated. The process is repeated.

Another example of a sequencing technique that can be used is nanopore sequencing (Soni, G. V., and Meller, A., 2007, Progress toward ultrafast DNA sequencing using solid-state nanopores; Clin Chem 53: 1996-2001). A nanopore is a small hole, of the order of 1 nanometer in diameter. Immersion of a nanopore in a conducting fluid and application of a potential across it results in a slight electrical current due to conduction of ions through the nanopore. The amount of current which flows is sensitive to the size of the nanopore. As a DNA molecule passes through a nanopore, each nucleotide on the DNA molecule obstructs the nanopore to a different degree. Thus, the change in the current passing through the nanopore as the DNA molecule passes through the nanopore represents a reading of the DNA sequence.

Another example of a sequencing technique that can be used involves using a chemical-sensitive field effect transistor (chemFET) array to sequence DNA (for example, as described in U.S. Pub. 2009/0026082). In one example of the technique, DNA molecules can be placed into reaction chambers, and the template molecules can be hybridized to a sequencing primer bound to a polymerase. Incorporation of one or more triphosphates into a new nucleic acid strand at the 3′ end of the sequencing primer can be detected by a change in current by a chemFET. An array can have multiple chemFET sensors. In another example, single nucleic acids can be attached to beads, and the nucleic acids can be amplified on the bead, and the individual beads can be transferred to individual reaction chambers on a chemFET array, with each chamber having a chemFET sensor, and the nucleic acids can be sequenced.

Another example of a sequencing technique that can be used involves using an electron microscope as described, for example, by Moudrianakis, E. N. and Beer M., 1965 in Base sequence determination in nucleic acids with the electron microscope, III. Chemistry and microscopy of guanine-labeled DNA, PNAS 53:564-71. In one example of the technique, individual DNA molecules are labeled using metallic labels that are distinguishable using an electron microscope. These molecules are then stretched on a flat surface and imaged using an electron microscope to measure sequences.

Sequencing generates a plurality of reads. Reads generally include sequences of nucleotide data less than about 150 bases in length, or less than about 90 bases in length. In certain embodiments, reads are between about 80 and about 90 bases, e.g., about 85 bases in length. In some embodiments, these are very short reads, i.e., less than about 50 or about 30 bases in length. After obtaining sequence reads, they can be assembled into contigs. Sequence assembly can be done by methods known in the art including reference-based assemblies, de novo assemblies, assembly by alignment, or combination methods. In some embodiments, sequence assembly uses the low coverage sequence assembly software (LOCAS) tool described in Klein, et al., 2001, LOCAS-A low coverage sequence assembly tool for re-sequencing projects, PLoS One 6(8) article 23455, the contents of which are hereby incorporated by reference in their entirety. Sequence assembly is described in U.S. Pat. No. 8,209,130; U.S. Pat. No. 8,165,821; U.S. Pat. No. 7,809,509; U.S. Pat. No. 6,223,128; U.S. Pub. 2011/0257889; and U.S. Pub. 2009/0318310, the contents of each of which are hereby incorporated by reference in their entirety.

After sequencing, in silico maps can be created from the contigs to assemble using a reference map. Any suitable reference map can be used. In certain embodiments, a reference map is an optical map generated by performing an optical mapping procedure on representative nucleic acid.

### Optical Mapping

FIG. 1 shows a method of optical mapping. From the nucleic acid sample, a plurality of single molecule optical maps are created. Optical mapping is a single-molecule technique for production of ordered restriction maps from individual molecules of nucleic acid. See Samad, et al., 1995, Optical Mapping: A Novel, Single-molecule Approach to Genomic Analysis, Genome Res. 5:1-4, 1995. During some applications, individual fluorescently labeled DNA molecules are elongated and fixed on the surface using methods of the invention. The added endonuclease cuts the DNA at specific points, and the fragments are imaged. Exemplary endonucleases include BgIII, NcoI, XbaI, and BamHI. Exemplary combinations of restriction enzymes are shown in Table 1.

TABLE 1
Exemplary Combinations of Restriction Enzymes

(AflII ApaLI BglII), (AflII BglII NcoI), (ApaLI BglII NdeI), (AflII BglII
MluI), (AflII BglII PacI), (AflII MluI NdeI), (BglII NcoI NdeI), (AflII
ApaLI MluI), (ApaLI BglII NcoI), (AflII ApaLI BamHI), (BglII
EcoRI NcoI), (BglII NdeI PacI), (BglII Bsu36I NcoI), (ApaLI BglII
XbaI), (ApaLI MluI NdeI), (ApaLI BamHI NdeI), (BglII NcoI XbaI),
(BglII MluI NcoI), (BglII NcoI PacI), (MluI NcoI NdeI), (BamHI
NcoI NdeI), (BglII PacI XbaI), (MluI NdeI PacI), (Bsu36I MluI
NcoI), (ApaLI BglII NheI), (BamHI NdeI PacI), (BamHI Bsu36I
NcoI), (BglII NcoI PvuII), (BglII NcoI NheI), and (BglII NheI PacI)

Restriction maps can be constructed based on the number of fragments resulting from the digest. Generally, the final map is an average of fragment sizes derived from similar molecules.

Optical mapping and related methods are described in U.S. Pat. Nos. 5,405,519, 5,599,664, 6,150,089, 6,147,198, 5,720,928, 6,174,671, 6,294,136, 6,340,567, 6,448,012, 6,509,158, 6,610,256, and 6,713,263. All of these patents are incorporated herein by reference.

Optical Maps may be constructed as described in Reslewic et al., 2005, Whole-Genome Shotgun Optical Mapping of Rhodospirillum rubrum, Appl Environ Microbiol, 71 (9):5511-22.

Briefly, individual molecules from a sample are immobilized on a surface such as derivatized glass by virtue of electrostatic interactions between the negatively-charged DNA and the positively-charged surface. Each molecule is digested with one or more restriction endonuclease and stained with an intercalating dye such as the green fluorescent dye sold under the trademark YOYO-1 by Life Technologies (Carlsbad, Calif.). The fragments may be imaged by an automated fluorescent microscope for image analysis. Since the chromosomal fragments are immobilized, the restriction fragments produced by digestion with the restriction endonuclease remain attached to the glass and can be visualized by fluorescence microscopy, after staining with the intercalating dye. The size of each restriction fragment in a chromosomal DNA molecule is measured using image analysis software. Each molecule immobilized on the surface thus produces a single molecule optical map.

Optical mapping can be used to create a physical map of a reference genome that can be used as a reference map for contig assembly.

FIG. 2 gives a diagram for methods of assembling contigs using a reference optical map. First, nucleic acid can be sequenced as described above to generate a plurality of sequence reads, which are then assembled into contigs. Then, in silico optical maps are generated for the contigs. The contigs are evaluated to determine a placement confidence for each contig.

### Placement Confidence

Methods of the invention include evaluating contigs for placement confidence. Any method of evaluating the placement confidence can be used. For example, in some embodiments, a placement confidence score C is assigned to each contig (e.g., with C between 0 and 1 or some other scale). Methods can include determining C as a normalized measure of size, setting the largest contig to length 1 and zero to 0.

Placement confidence may be determined by referencing a sequence quality score. For example, Phred quality scores can be incorporated into a valuation of a contig placement confidence, or any other sequencing quality score.

In some embodiments, determining placement confidence can include counting a number of sequence reads per contig (e.g., as an estimate of coverage). Accordingly, contigs with a high placement confidence score C will comprise a large number of reads. Any contigs that are made up of very few reads (e.g., two reads) will receive a very low placement confidence C. In a related embodiment, placement confidence C includes a measure of overlap between sequence reads. For example, two sequence reads that overlap by more than 20 bp contribute much more to C than two reads that overlap by 2 bp.

In certain embodiments, placement confidence C includes an assessment of the presence of certain marker patterns. For example, where a target is known to include certain characteristic pattern of restriction sites, the presence of that pattern in a contig sets C to be 1.

In some embodiments, C is an alignment quality score obtained by performing a rapid, heuristic alignment of contigs to a reference (e.g., a “quick and dirty” one-pass alignment). It will be appreciate that methods are known in the art for doing alignments very rapidly according to a simplifying heuristic. Once C has been established by a heuristic alignment, the contigs may be passed to assembler where they may be aligned to the reference by means of an exhaustive algorithm.

In certain embodiments, C includes a measure of cut sites per unit length, or a ratio of cut sites for one enzyme per unit length to a number of cut sites per unit length for another enzyme. In particular versions of these embodiments, the number of cut sites per unit length (or the ratio) is converted to C by making reference to the same measurement for the reference map. Thus, contigs with a cut site per unit length value (or ratio) approaching the cut site per unit length value of the reference map get a high C score, with C score decreasing for contigs with cut site per unit length measures progressively more distant from the value for the reference map.

In certain embodiments, C is determined by modeling a number of cut sites for a presumptively non-effective enzyme. For example, where an organism being studied is a microorganisms with a methylation-based restriction resistance mechanism, the appearance of restriction sites in the contigs can contribute to low value of C.

In some embodiments, C is determined by using

C=k×(n²/(n²+1))×(aL+bn−c[|(n/L)−(nₘ/Lₘ)|)

where n is the number of cut sites in the contig, L is the length of the contig, (nₘ/Lₘ) is the number of cut sites per unit length of the map, and k, a, b, and c are constants that can be set to 1 or are free to be optimized for the data set. It will be appreciated that C is 0 where n is 0 and that C increases for greater n, greater L, as well as a better match of cut density between contig and map. Contigs with no sites are ignored by this embodiment. One of skill in the art will recognize related embodiments useful for performing the methodologies described herein.

Once the placement confidence is determined, the contigs are passed to an assembler (e.g., a module in a computer-based analysis system) in order by placement confidence. The contigs with a high placement confidence are assembled by alignment to the reference map first. Then, contigs with lower placement confidence are assembled. Finally, the contigs with the lowest placement confidence scores are assembled. As a results, a genome is assembled.

### Assembly

FIG. 4 illustrates a nascent assembly according to certain embodiments. In general, the contigs with highest values for placement confidence C are aligned to the map first. Map alignments can be generated with a dynamic programming algorithm that finds the optimal alignment of two maps according to a scoring model that incorporates fragment sizing errors, false and missing cuts, and missing small fragments. See e.g., Myers and Huang, 1992, An O(N² log N) restriction map comparison and search algorithm, Bull Math Biol 54(4):599-618 and Waterman et al., 1984, Algorithms for Restriction Map Comparisons, Nucleic Acids Res 12(1 Pt 1):237-242. For a given alignment, the score is proportional to the log of the length of the alignment, penalized by the differences between the two maps, such that longer, better-matching alignments will have higher scores. Aligning one contig to the reference map can include provisionally aligning the contig to numerous different places along the reference, scoring each alignment, and keeping the one alignment that produces the best score. Each alignment may be scored by methods known in the art. For example, for each alignment, a “percent dissimilarity” between the contig and the reference can be calculated.

In some embodiments, assembly proceeds by a computer program that implements the algorithm known as Gentig. Gentig uses an approximation algorithm for finding an almost optimal scoring set of contigs, while constraining the false positive error rate below a negligible value. Under a simple overlap rule, dubbed Type D, that determines when two genomic DNA molecules can be deemed to have a common sub-fragment, a conservative estimate of the false probability can be given as

$$\frac{4}{{p}_{c}^{4}} exp ( - β n / 2 ) {\sum }_{i = k}^{∞} \frac{{( β n / 2 )}^{i}}{i !}$$

where p_{c} is the digestion rate, B is the relative sizing error, n is the expected number of restriction fragments per genomic DNA molecule, and k is the integer parameter directly related to overlap threshold ratio theta. See Lin, et al., 1999, Whole-Genome Shotgun Optical Mapping of Deinococcus radiodurans, Science 285:1558-1562; U.S. Pat. No. 7,831,392 to Antoniotti; U.S. Pub. 2013/0045879 to Mishra; and U.S. Pub. 2003/0087280 to Schwartz, the contents of each of which are incorporated by reference.

In certain embodiments, alignments are scored by approximating distribution counts of compared pairs and computing the probability of a match according to the Chen-Stein method. The Chen-Stein method approximates the distribution of occurrences of dependent events by the Poisson distribution. See Tang and Waterman, 2001, Local Matching of Random Restriction Maps, J Appl Prob 38:335-356; U.S. Pat. No. 6,340,567 to Schwartz; and U.S. Pub. 2005/0064406 to Zabarovsky, the contents of each of which are incorporated by reference. Assembly of optical maps is discussed in U.S. Pub. 2013/0029877 to Dykes; U.S. Pub. 2012/0183953 to Xiao; and U.S. Pub. 2007/0148674 to Berres, the contents of each of which are incorporated by reference.

As described above, the invention provides systems and methods for generating genomic assemblies from a sample containing nucleic acid. The genomic assemblies may be used for comparative genomics analysis to identify structural variations, including intra- and inter-chromosomal rearrangements. For example, the assembled contigs can be analyzed using any of a variety of comparative genomics analysis techniques to reveal structural variations, including intra- and inter-chromosomal rearrangements. Comparative genomic analysis using optical maps is shown for example in Zhou et al., 2004, Single-molecule approach to bacterial genomic comparisons via optical mapping, J Bacteriol., 186(22):7773-7782, the content of which is incorporated by reference herein in its entirety.

### Hardware Systems

FIG. 3 depicts a system 129 for sequencing nucleic acid and assembling sequence information. System 129 may generally include a bench computer system 104 coupled to wet work instruments. For example, system 104 (FIG. 3) may operate hardware that combines capillary flow technology for nucleic acid, e.g., DNA or RNA, deposition onto a surface with computer-controlled flow processing. Additionally, bench system 104 may control the operation of one or more sequencing instruments, such as any of those described above. For computer control, system 104 includes a processor 139 coupled to a memory 137 and input/output mechanisms 135. System 104 may control sequencing instruments, optical mapping instruments, or both. Sequencing instruments are described above.

In the optical mapping instruments, a capillary flow presents the nucleic acid molecules to a derivatized surface in long strands that are captured and held to the surface by electrostatic attraction. Once the nucleic acid molecules have been captured on the surface, reagents (e.g., washing solutions, buffers, enzymes, and nucleic acid stains), are flowed to and from the surface to produce restriction digests. The digests are subsequently imaged, thereby characterizing the nucleic acid molecule. The system may include a cartridge for characterizing a nucleic acid molecule, the cartridge including a reaction chamber having a derivatized bottom surface, at least one reagent reservoir, and a pump, in which the reaction chamber, the reagent reservoir, and the pump are fluidically connected to each other. The cartridge uses microfluidic components to link on-board reagent reservoirs via computer controlled valves and plumbing to a reaction chamber having a derivatized bottom surface. The derivatized bottom surface assists in elongating and fixing nucleic acid molecules, e.g., DNA or RNA, onto a surface so that the nucleic acid molecules remain accessible for enzymatic reactions. In certain embodiments, the derivatized bottom surface is derivatized glass.

The cartridge can be operably linked to bench system 104. Depending on the embodiment, the cartridge can further include at least one of the following: a reagent waste pad, a channel forming device configured to mate with the reaction chamber, a reaction chamber cap, or a heater/cooling device. The heater/cooling device can be located beneath the reaction chamber. In certain embodiments, the at least one reagent reservoir is a plurality of reservoirs, in which a first reservoir holds a TE wash reagent, a second reservoir holds a buffer, a third reservoir holds an enzyme, and a fourth reservoir holds a nucleic acid stain. Each reservoir can further include a loading port and a computer controlled valve for controlling flow of reagents from the reservoirs to the reaction chamber.

The cartridge is placed on the wet work instruments, reagents are loaded into the cartridge, using the loading ports associated with each reservoir. Loading can be accomplished by using any commercially available pipette. Once the reagents have been loaded, the orientation of the cartridge is adjusted to optimize flow of reagents within the cartridge. The cartridge can be placed flat (0° angle) on the surface of the preparation station. Alternatively, the cartridge can be oriented 90° to the surface of the preparation station. Generally, the cartridge can be oriented from about a 0° angle to about a 180° angle with respect to the surface of the preparation station. In a particular embodiment, the cartridge is tilted to a 60° angle with respect the surface of the preparation station in order to optimize reagent flow within the cartridge.

Once the cartridge has been oriented at the optimally determined angle for reagent flow, the preparation station (e.g., under the control of bench system 104) activates the pump in the cartridge and reagents are moved to the reaction chamber from the reservoirs and then aspirated from the reaction chamber to the reagent waste pad. The preparation station controls reagents exchange in the reaction chamber, flow rates, and temperature of the reaction chamber as required to complete washing, enzymatic digestion, and staining of the nucleic acid molecules for generation of restriction digests of the nucleic acid molecules. Further, flow is controlled (e.g., slow flow rates and controlled volumes) such that the nucleic acid molecules are not dislodged from the bottom surface of the reaction chamber.

Once the automated process is completed, the loading ports and any vent holes in the cartridge are sealed e.g., with adhesive tape or labels, and the cartridge is ready for readout on a imaging device, such as a fluorescing microscope operably linked via the computer system to a monitor or data storage. System 129 can thereby identify or measuring each single molecule restriction map. Exemplary systems for optical mapping are discussed in U.S. Pub. 2013/0029323 to Briska, the contents of which are incorporated by reference.

The computer system 129 optionally includes modules for visualization, editing, or analyzing optical maps, which can be provided by, for example, a computer device 105 or a server 133 operating over a network 131. In certain embodiments, the system includes software modules, a database, or a combination thereof that provide similarity metrics, grouping, storage, assembly, and scaffolding as described herein. Preferably, the system provides contig linking and branched-path visualizations for heterozygous study samples. The system may additionally provide multi-tracked display of single molecule optical map data alongside external genomic data such as genes, sequence coverage, STS markers, SNP sites, CpG islands, chromosome banding, GC content, amino acid sequences of the encoded proteins, primary and tertiary structures of the encoded proteins, and molecules or agents that potentially interact with the DNA molecules or the encoded proteins, and other data collected from one or more external databases as indicated further infra.

Server 133 including memory 147 coupled to processor 149 and input/output connections 145 may include a database 151 that includes records 155 such as one or more of a flat file, a relational database, an object database or a data warehouse. A suitable relational database server for the system is, e.g., MySQL. Other examples of object databases that may be used include JYD Object Database or Objectivity/DB by Objectivity Inc. (Sunnyvale, Calif.). The database may be a data warehouse or a distributed database deployed over a network.

The system may include visualization and editing tools such as additional connectors that link the system to additional databases. These additional databases may also store information on single molecules and other biomedical information. These databases may be external databases such as those accessible over the Internet, e.g., GENBANK, SWIS-PROT, OMIM, and the NCBI SNP Database. The computer visualization and editing system can provide for visualization and editing of restriction maps as well as validation of these maps with sequence data retrievable from the connected databases.

In certain embodiments, computer device 105 provides a user interface (e.g., via input/output mechanism 135) that is capable of displaying genome assemblies. A user may view the assembly of contigs and, if necessary, minimally edit these data by simple selection and keystroke. Memory 137 coupled to processor 139 may perform steps described herein. Exemplary systems are described in U.S. Pat. No. 8,271,251 to Schwartz; U.S. Pub. 2013/0045879 to Mishra; and U.S. Pub. 2012/0254715 to Schwartz, the contents of each of which are incorporated by reference.

The methods disclosed herein are capable of being carried out by one or more general-purpose computers that are programmed by one or more software applications. And, in particular, it is noted that the processing depicted in FIG. 1 can be carried out by such one or more computers. Each of the one or more programmed computers will include at least one processor and one or more types of storage such as RAM, ROM, hard disk, optical disk, etc. The computer(s) typically also will have locally and/or will have access to remotely one or more databases containing data representative of the optical maps, DNA information, and other real-world chemical and/or biological elements, compounds, etc. that are disclosed herein. These data are processed by the programmed computer(s) to perform the steps and accomplish the methods disclosed herein.

As shown in FIG. 3, device 105 may include a PC, tablet, or any other suitable device. Device 105 will generally include a memory 137 coupled to a processor 139 as well as an input/output mechanism 135. Server 321 may include one or more computer devices using one or more of processor 149 coupled to memory 147 as well as input/output device 145. Memory 137 or may be taken to include one or more of a volatile or persistent memory such as RAM or storage. Computer storage can be provided by a hard drive (e.g., magnetic disk drive), flash memory, solid state drive (SSD), removable compact flash card, or similar. Processor 139 or 149 will generally include one or more computer processor such as a microchip made by Intel. Input/output 135 or 145 may include a mouse, keyboard, monitor, screen, touchscreen, network interface card, Wi-Fi card, cellular modem, Ethernet jack, USB jack, radio-frequency identification transponder, similar, or combinations thereof. Device 105 may be in communication with server 133 via network 131. Network 131 may include one or more of a wireless or wired internet communication device (e.g., router, hub, or switch), cellular tower, modem, land lines, satellites, antennae, similar structures, or a combinations thereof. Server 321 may house a database 151 that includes records 155 wherein may be stored any of the information described or required herein. Any such information may additionally or alternatively be stored in memory 137. Preferably, memory 137 or memory 147 is a tangible, non-transitory device that may contain the instructions executable to cause a system or device of the method to perform any of the steps, methods, or functions described herein. Exemplary computer systems for implementing methods disclosed herein are discussed in U.S. Pub. 2012/0249580 to Schwartz. As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method of assembling sequence contigs, the method comprising:
obtaining a plurality of sequence contigs;
determining a placement confidence score for each contig;
identifying a subset of the plurality of sequence contigs with a threshold placement confidence score;
aligning the contigs of the subset to a genomic map; and
aligning a remainder of the contigs to the genomic map.

2. The method of claim 1, further comprising aligning the contigs to the genomic map in order by placement confidence score.

3. The method of claim 1, wherein the placement confidence score comprises a length of a contig.

4. The method of claim 1, wherein the placement confidence score comprises a quality score.

5. The method of claim 1, wherein the subset is identified prior to any alignment of contig to map.

6. The method of claim 1, wherein the placement confidence score comprises a similarity metric.

7. The method of claim 6, wherein the subset comprises contigs that are most dissimilar to all of the other contigs in the plurality of sequence contigs.

8. The method of claim 1, wherein further comprising generating the genomic map by:
introducing nucleic acid from the sample to a charged substrate so that the nucleic acids become elongated and fixed on the substrate in a manner in which the nucleic acids remain accessible for enzymatic reactions;
digesting the nucleic acids enzymatically to produce one or more restriction digests; and
constructing a map from the restriction digests.

9. The method of claim 8, wherein the substrate is derivatized glass.

10. The method of claim 1, wherein the sample comprises human tissue or fluid.

11. The method of claim 1, further comprising generating an in silico optical map of at least some of the plurality of sequence contigs.

12. The method of claim 6, wherein the similarity metric comprises a measure of a number of cutting sites per length of nucleic acid molecule for a restriction enzyme.

13. The method of claim 1, further comprising:
using a computer system to perform the recited steps, wherein the computer system comprises a processor and a non transitory memory.
